(19) United States
(12) Patent Application Publication
(10) Pub. No.: US 2003/0180088 A1
(43) Pub. Date: Sep. 25, 2003

(54) Flexible electronic mount apparatus

(76) Inventor: Jeffrey D. Camevali, Seattle, WA (US)

Correspondence Address: Charles J. Rupnick, PO Box 46752, Seattle, WA, 98146, US

(21) Appl. No.: 10/392,613

(22) Filed: Mar. 19, 2003

Related U.S. Application Data
(63) Continuation of application No. 09/654,245, filed on Sep. 2, 2000, now abandoned.

(51) Int. Cl. F16C 11/06

(52) U.S. Cl. 403/56

(57) ABSTRACT

A substantially stable but universally adjustable ball and socket mounting device formed of a base adapted for permanent mounting on a substantially flat surface and an interconnected equipment mounting element optionally interconnected by one or more rotatably interconnecting columnar ball and socket elements.

### BACKGROUND OF THE INVENTION

The present invention relates generally to flexible mounting apparatus and particularly, to molded plastic interconnecting ball and socket elements in combination with opposing universally mountable base and universal coupler interconnected thereto.

Mounting devices for adjustably mounting rear view mirrors in automobiles are generally well-known. Perhaps the most common device is that disclosed in U.S. Pat. No. 4,382,572 entitled, MOUNTING APPARATUS FOR REAR-VIEW MIRRORS AND THE LIKE issued to Thompson on May 10, 1983, which describes a pivoting apparatus for attaching a rear-view mirror to a windshield, which includes a ball projecting from a base mounted on the glass of the windshield and a ball projecting from the backside of a mirror, each ball permanently captured within one of two sockets formed at opposite ends of a two-piece tubular rod.

The need to use the working hours efficiently has given rise to many people using their automobile as an extension of the office. Such usage requires the presence of street maps and note pads, and more recently, electronic equipment. Mounting devices for holding note pads and electronic equipment are also generally known. U.S. Pat. No. 5,769,369 entitled, MOBILE OFFICE STAND FOR SUPPORTING A PORTABLE COMPUTER OR ELECTRONIC ORGANIZER IN VEHICLES, issued to Meinel on Jun. 23, 1998, for example discloses an apparatus for supporting and holding an electronic organizer in a vehicle, which includes a cradle for holding the device between a pair of jaws. A ball projecting from the backside of the cradle fits into a lockable split skirt socket in a rigid arm releasably mated with a support base.

Each of these mounting devices are severely limited as flexible mounting devices for today's electronic devices, such as computers and wireless telephones. The double ball and socket rear-view mirror mount taught by Thompson permanently captures the two ball ends in the sockets, and therefore, fails to provide the ability to easily remove and re-install a piece of equipment for use both inside and outside the automobile. Although apparently capable of supporting relatively heavy loads, the mobile office stand taught by Meinel requires the user to use both hands to adjust the orientation of the mounted equipment, one hand to loosen and retighten the clamps and the other to adjust the equipment orientation. Such labor intensive adjustment mechanisms are unsafe in a driving situation.

A “snake” chain device that is adjustable in a conical sweep zone is generally used for directing lubricant and air to a machine cutting tool, as disclose by Brice in U.S. Pat. No. 5,725,071, entitled MACHINE CUTTING TOOL SELECTIVE LUBRICATOR WITH AIR BLOW-OFF, issued Mar. 10, 1998, the complete disclosure of which is hereby incorporated by reference. In part, Brice describes a system to selectively lubricate and to supply a forced airflow onto a machine cutting tool which includes a tube formed of a series of interconnected articulated tubular ball and socket linkages that can be relatively rotated or pivoted about the geometrical center point of the ball element until an edge of the socket of one linkage rests against a shoulder formed by the outer wall of the socket of the interconnected linkage. The linkages are formed with a close fit and relatively fine finish intended to create an air and lubricant seal when interconnected. However the tension generated between the ball and the socket is traditionally designed to merely maintain a relative orientation between adjacent linkages against the forces of gravity and vibration and the pressures generated by the lubricating and forced airflow systems while being easily manipulated by hand, rather than to support additional external weights or objects.

U.S. Pat. 4,648,733, entitled DEVICE FOR PRODUCING AN INSTALLATION TEMPLATE FOR CONDUITS, ESPECIALLY CONDUITS FOR HYDRAULIC OR PNEUMATIC CONTROL OR PROCESS CIRCUITS, issued to Merkt on Mar. 10, 1987, the complete disclosure of which is hereby incorporated by reference, discloses linkages formed of plastic to impart a “spatial” elasticity that makes possible pressing the socket portion onto the ball portion with relatively little force, and also creates tension between the ball and the socket when the articulated elements are joined together. Merkt discloses using interconnected articulated ball and socket linkages having a solid cross-section in a device for producing an installation template for conduits, wherein the device includes end pieces that mate with the articulated elements and are provided with connectors for rod elements that are several times longer than the articulated linkage elements and are apparently intended for forming straight sections of conduit. Each of U.S. Pat. 4,123,930, entitled MANDREL FOR BENDING TUBES, issued to Hill, et al on Nov. 7, 1978, and U.S. Pat. No. 4,315,423, entitled TUBE BENDING MANDREL, issued to McGuire on Feb. 16, 1982, the complete disclosures of which are hereby incorporated by reference, disclose more complex variations of the interconnected solid cross-section articulated ball and socket linkages for producing installation templates for conduits.

U.S. Pat. No. 5,174,164 to Wilheim issued Dec. 29, 1992, entitled FLEXIBLE CABLE, the complete disclosure of which is hereby incorporated by reference, generally discloses using interconnected articulated ball and socket linkages having a tubular cross-section in a flexible cable for carrying an inspection probe along the inside surface of a tube. The cable includes a plurality of adjacent interconnecting globular beads surrounding a core member, with each pair of adjacent beads defining a ball and socket joint that allows the cable to flex without seizing or doubling-back on itself within the inspected tube. The beads are formed of a material, such as plastic, having a low coefficient of friction to allow the bead to slide or glide with minimal friction along inside surface of the inspected tube.

U.S. Pat. No. 4,397,145, entitled UNIVERSAL LINK CHAIN, issued to Reist on Aug. 9, 1983, the complete disclosure of which is hereby incorporated by reference, generally discloses using a series of interconnected articulated ball and socket linkages having a complex solid cross-section to form a chain of relatively rotatable link elements having minimal axial relative displacement.

U.S. Pat. No. 4,771,500, entitled PLUMBERS SNAKE, issued to Kovacs on Sep. 20, 1988, the complete disclosure of which is hereby incorporated by reference, generally discloses using a series of columnar elements having a ball member formed at one end and a cylindrical cavity formed at the other end to form a plumbers snake. During installation, the opening of the cylindrical cavity of each columnar element is formed with a reduced neck portion that is deformed to capture the ball portion of an interconnected columnar element by forcing the interconnecting columnar element against the reduced neck portion with a hammer blow.

Generally, the above U.S. Patents disclose ball and socket assemblies that are inherently easily relatively rotatable to suit the intended usage, rather than assemblies that resist relative motion to such an extent that external loads can be supported. Each of these ball and socket assemblies provide relative linkage rotation with minimal applied force for ease of travel within a tube, pipe or conduit, and each also assures minimal relative rotational resistance during the bending or forming of a tube around a chain of interconnected ball and socket link elements.

In contrast to the above disclosed easily rotatable ball and socket-type linkages, various other inventions generally teach ball joint links and structures formed thereof for supporting relatively heavy external loads. For example, U.S. Pat. No. 4,898,490 to Herbermann, et al issued Feb. 6, 1990, entitled STRUCTURE FORMED FROM BALL JOINTED LINKS, the complete disclosure of which is hereby incorporated by reference, generally discloses forming a complex, load bearing structure from a series of steel ball and socket links joined to one another end to end, with the ball and socket sized so that the ball fits snugly within the socket. Longitudinal slots splitting the skirt of the socket allow the ball and socket connection to be a snap fit. A weld, solder or adhesive joint is formed between adjacent links to maintain relative orientation. Later, in U.S. Pat. 5,921,694 issued Jul. 13, 1999, entitled BALL JOINTED LINKS, the complete disclosure of which is hereby incorporated by reference, Herbermann generally discloses cylindrical ball jointed links with a socket angularly oriented to the cylindrical element, the skirt of the socket being made radially inwardly deformable relative to the ball element. A clamp tightened around the socket radially inwardly deforms the socket to secure the relative orientation of adjacent links for supporting relatively heavy loads.

What is needed is a universal, easily adjustable but stable mounting device for use in an automobile, boat, or other vehicle to hold relatively light external loads. In particular, what is needed is an easily adjustable universal mounting device to hold small office items, such as street maps and note pads, and relatively light weight electronic instruments, such as hand-held computers, navigation devices and wireless telephones.

### SUMMARY OF THE INVENTION

The present invention overcomes the limitations of the prior art by providing a substantially stable, load-bearing but relatively adjustable ball and socket mounting device formed of a base adapted for permanent mounting on a substantially flat surface and an equipment mounting element either directly interconnected or optionally interconnected by one or more rotatably interconnecting ball and socket elements.

According to one aspect of the invention, the invention provides an adjustable ball and socket mounting device including two mounting elements, each integrally formed with a base and one of a socket and a part spherical tip, the socket sized a predetermined amount smaller than the tip to slidingly engaging the part spherical tip in a resistively relatively radially rotatable interference fit with sufficient elastic clamping force to maintain relative orientation between the first and second mounting elements while supporting an external load at the second mounting element.

According to other aspects of the invention, the socket is formed of a part hemispherical chamber and an opposing annulus wherein. According to one aspect of the invention, the annulus opposes the part hemispherical chamber across an equatorial plane of the socket, the annulus defining an inner rim spaced a radial distance less than or equal to the radius of the chamber away from the center of the equatorial plane of the part hemispherical chamber. The annulus preferably is formed as a second part hemispherical chamber portion opposing the first part hemispherical chamber.

According to yet other aspects of the invention, the mounting device of the invention further includes one or more elongate ball and socket elements interconnected between the socket and the part spherical tip. According to one aspect of the invention, the elongate ball and socket element is made up of a socket formed in one end of a part hemispherical chamber and an opposing annulus each sized substantially identically to a respective one of the part hemispherical chamber and said annulus of the mounting element, and a part spherical tip formed in an opposing end and sized substantially identically to the part spherical tip of the mounting element. Preferably, the interconnected ball and socket element includes a conical body having the socket formed in the base thereof, with the part spherical tip truncating the vertex of the conical body at a position along the longitudinal axis thereof having a diameter less than the diameter of the part spherical tip.

According to another aspect of the invention, a first mounting element is integrally formed with a mounting base adapted to permanently attach to a surface external to the mounting device and a second mounting element is integrally formed with a base adapted to permanently attach to a load external to the mounting device. Each of the first and second mounting elements are formed with the same one of a part spherical tip and a socket formed of a part hemispherical chamber and an opposing annulus. The socket is formed having a diameter slightly smaller than that of the part spherical tip so that the socket is sized to slidingly engage the part spherical tip in a resistively relatively radially rotatable interference fit which exerts sufficient elastic clamping force to maintain relative orientation between the first and second mounting elements while supporting an external load at the second mounting element. A link element is integrally formed with two of an other type of connection, either the part spherical tip or the socket. The link element interconnects the first and second mounting elements. The first and second mounting elements and the link element are each molded of a relatively rigid and highly resilient non-metallic material. According to one aspect of the invention, the first and second mounting elements are formed with substantially identical sockets, while the link element is a substantially columnar body formed with one part spherical tip at each opposing end thereof According to another aspect of the invention, the first and second mounting elements are formed with substantially identical part spherical tips, and the link element is formed of a substantially columnar body with one socket at each opposing end thereof

According to another aspect of the invention, each of the elements of the mounting device is molded of a relatively rigid and highly resilient non-metallic material.

According to one aspect of the invention, the invention provides an adjustable ball and socket mounting device including at least one ball and socket element formed of an elongate column having a part hemispherical or cup-shaped socket formed in one end with and an opposing annulus formed in the end surface opposite the pole of the socket. The elongate column preferably tapers to an end distal from the socket where it is formed with a rounded, part spherical or bulbous tip having a diameter larger than either the major diameter of the socket, the inner diameter of the annulus, or the diameter of the tapered column at a point adjacent to the tip. Preferably, the socket, the opposing annulus, and the part spherical tip are each formed substantially symmetrically with a longitudinal axis of the elongate column. A first mounting element is integrally formed with a part spherical portion that is sized substantially identically to the part spherical tip of the elongate ball and socket element and projects from a base, which is adapted to permanently attach to a surface external to the mounting device. A second mounting element is having an integral part hemispherical socket and an opposing annulus, each sized substantially identically to a respective one of the part hemispherical socket and annulus of the elongate ball and socket element, the socket and opposing annulus formed integrally within the second mounting element distal from a base adapted to permanently receive an attachment thereto.

According to another aspect of the invention, when assembled into the mounting device of the invention, the elements form an assembly that is rotatably adjustable within a predetermined conical sweep zone. According to the invention, the generally spherical shape of the rounded tip defines a fixed pivot point within the cup-shaped cavity, the pivot point defining the vertex of the conical sweep zone. Physical contact between the base of one elongate column and an outer wall of an interconnected elongate column adjacent to its bulbous end portion restricts the conical sweep zone relative to that column element.

According to another aspect of the invention, the part spherical tip that, while truncated inwardly of each pole, further includes sufficient surface area to define a partial sphere extending toward each opposing pole on respective sides of its equatorial plane.

According to another aspect of the invention, each elongate column is formed with an inner wall that defines a substantially cylindrical longitudinal bore therethrough and preferably communicating with the polar region of the part hemispherical socket and an interior portion of the part spherical tip.

According to another aspect of the invention, the first mounting element formed with the part spherical projection further includes a columnar projection formed between a surface of the base having the part spherical tip integrally mounted on an end thereof opposite from the base, and a mounting surface formed on a surface of the base opposite the rounded tip.

According to another aspect of the invention, the equatorial plane of the socket has a diameter smaller than the major diameter of the rounded tip and the annulus opposing the part hemispherical socket across its equatorial plane so that the annulus is formed to contact and urge the rounded tip toward the pole of the part hemispherical socket. In other words, the cavities and rounded tips are sized to form an interference fit one with the other, such that slidingly engaging of one of rounded tips by one of the cavities compresses the rounded tip while expanding the socket.

According to yet another aspect of the invention, the annulus is either a substantially continuous annular ring formed in a substantially planar base surface of the elongate column opposite the rounded tip and perpendicular to the column's longitudinal axis, or a second part hemispherical socket portion opposing the first part hemispherical socket across the equatorial plane of the socket, i.e., the socket is a spherical cavity formed in the elongate column partly overlapping and truncated by the end surface of the column. In either case, the opening into the socket is sized to slidingly engage the rounded tip under force. When the annulus is formed as an annular ring, the ring's inner diameter facing the socket is sufficiently less than the coincident diameter of an inserted rounded tip to contact and urge the rounded tip toward the pole of the part hemispherical socket. Similarly, when the annulus is formed as a second part hemispherical socket portion, its diameter is sufficiently less than that of the rounded tip to contact and urge an inserted rounded tip toward the opposite pole of the part hemispherical socket.

According to other aspects of the invention, the invention provides a method for mounting office or electrical equipment in a vehicle, such as an automobile, boat, or aircraft. The method includes permanently mounting on a substantially planar surface a mounting base formed with either a rounded projection or a cavity sized to partially surround and resistively relatively radially rotatably engage the rounded projection. The method includes interconnecting to the mounting base an equipment mount formed with a mounting surface adapted for mounting of an equipment mounting receptacle and the opposite one of the rounded projection and the cavity.

According to another aspect of the method of the invention, the method includes interconnecting between the mounting base and the equipment mount one or more substantially rigid link elements each having a rounded end portion and an opposing cavity each formed substantially identically to a respective one of the rounded projection and the cavity.

### BRIEF DESCRIPTION OF THE DRAWINGS

FIG. 1A is a perspective view illustrating one embodiment of the link element of the present invention;

FIG. 1B is a section view taken through the link element of FIG. I A;

FIG. 2 illustrates the assembly of two of the link elements of the present invention;

FIG. 3 illustrates the assembly of the adjustable ball and socket mounting device of the present invention, including a base adapted for permanent mounting on a substantially flat surface, a mounting element adapted for mounting various office and/or electronic equipment, and multiple rotatably interconnecting columnar ball and socket elements interconnecting the two;

FIGS. 4A and 4B, respectively, illustrate the assembly of a male mounting base with a female equipment mount, and a female mounting base with a male equipment mount

FIGS. 5A through 5E illustrate various adaptations to the mounting elements of FIG. 4;

FIGS. 6A and 6B illustrate both male and female mounting bases according to the invention adapted for mounting on a substantially vertical vehicle surface;

FIG. 7 illustrates one alternative embodiment of the link element of the present invention,

FIGS. 8A and 8B illustrate other alternative embodiment of the link element of the present invention having multiple branches projecting from a single stem; and

FIGS. 9A and 9B illustrate yet other alternative embodiments of the link element of the present invention for interconnecting same gender mounting bases and equipment mounts.

### DETAILED DESCRIPTION

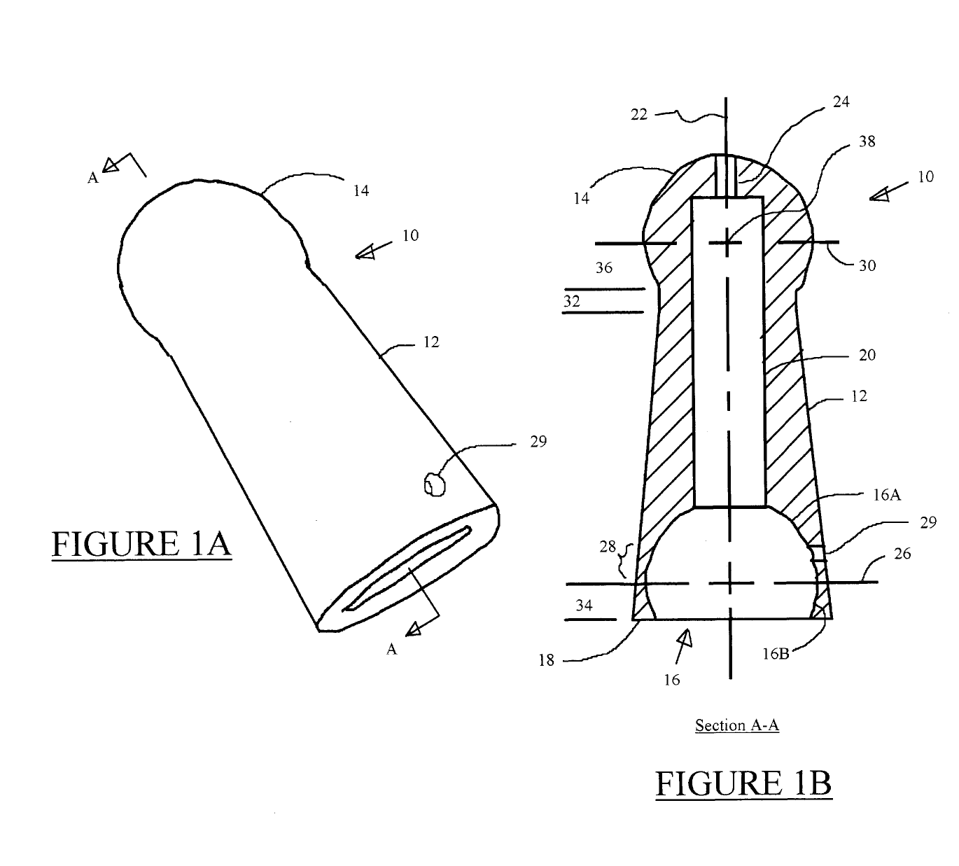

FIGS. 1A and 1B shows one of the links 10 of the present invention for forming the adjustable mounting device of the invention. FIG. 1A is a perspective view of link 10, while FIG. 1B is a section view taken through FIG. 1A, as indicated. As illustrated, the exterior of link 10 is formed using simple, geometric shapes: a cone body 12 truncated at its tip by a sphere 14. The interior of link 10 is also formed using simple, geometric shapes. A part spherical cavity 16 is formed within conical body 12 intersecting the plane of base 18. Thus, each link 10 includes a truncated conically-shaped column (truncated cone body 12) having the cup-shaped cavity (part spherical cavity 16) formed within the base of the conically-shaped column 12. Each of cavity 16 and spherical tip 14 are respectively sized to elastically relatively radially rotatably engage the other. When molded of a relatively rigid, high-resiliency non-metallic material, preferably a plastic material, this combination of simple shapes is easily produced, resulting in an inexpensive link device.

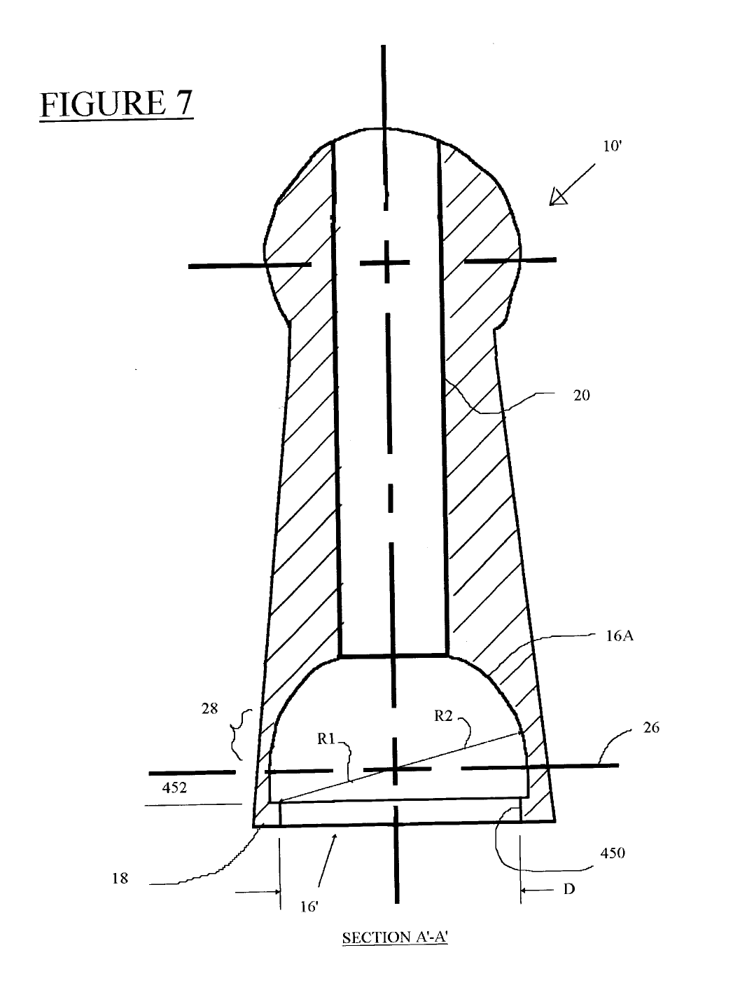

Preferably, conical body 12 is lightened by a generally cylindrical hollow cavity 20 formed coincident with longitudinal axis 22. The molding process used to manufacture link 10 optionally includes a slight draft angle for cavity 20 to facilitate ejection from the mold. Cavity 20 optionally extends into and significantly hollows out the interior of spherical tip 14. A optional pin (not shown) for positioning the portion of the mold that forms both spherical cavity 16 and cylindrical cavity 20 may be advantageous to the molding process and forms a small preferably cylindrical passage 24 through the pole of spherical tip 14. According to yet other embodiments of the invention, cavity 20 extends through the complete longitudinal length of body 12, as shown in FIG. 7.

Cavity 16 defines an equatorial plane 26 that is substantially perpendicular to the longitudinal axis 22 of conical body 12. Equatorial plane 26 defines, in turn, two opposing hemispheres on either side of equatorial plane 26 that together form cavity 16. A first hemisphere 16A of cavity 16 lies on the side of plane 26 toward the interior of conical body 12, while a second hemisphere 16B lies on the opposite side of plane 26, toward base 18. Base 18 defines a plane 24 substantially parallel with and spaced away from equatorial plane 26 that intersects and truncates second hemisphere 16B of cavity 16. The truncation eliminates a polar region of second hemisphere 16B substantially concentric with longitudinal axis 22 and thereby forms an opening into cavity 16. The opening is substantially circular with a diameter less than the diameter of cavity 16, which is, in turn, less than the diameter of spherical tip 14, as mentioned above. The size of the opening is a function of several variables and is discussed below.

Optionally, a small passage 29 is formed between the outer surface of body 12 and cavity 16. Passage 29 is utilized to apply a low-viscosity adhesive, such as one of the cyanoacrylates, which are commercially available under the popular name “super glue,” whereby the relative orientation of two links is permanently fixed. The diameter of passage 29 is on the order of about 1/32 inch to ⅛ inch, or another diameter suitable to the introduction of such an adhesive. As discussed below, passage 29 is optionally included in various other elements of the invention, whereby such an adhesive is introduced into the assembly to permanently secure relative orientation.

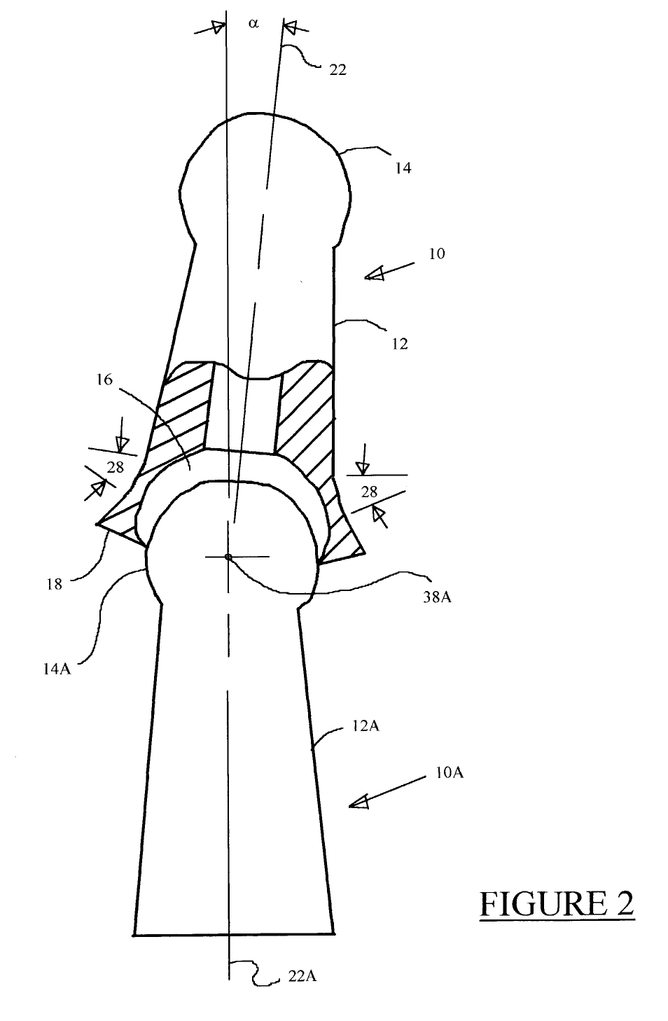

FIG. 2 is an exaggerated illustration of the assembly of two links 10. The bulbous tip 14A of a second link 10A is inserted into the cup-shaped cavity 16 of link 10 by substantially aligning their respective longitudinal axes 22A and 22 and pressing them together, as indicated by the arrows. The presence of cavity 16 forms a variably thickness wall within conical body 12. As shown in FIGS. 1B and 2, the wall thickness thins from a maximum near the pole of first hemisphere 16A opposite equatorial plane 26 to a minimum near equatorial plane 26, and increases again past equatorial plane 26 toward base 18. The thin wall area 28 forms a relatively flexible area around the entire periphery of conical body 12. During installation, rounded end tip 14A of second link 10A is forcefully inserted through the opening in base 18 into cavity 16. Factors such as the choice of mold material and the thickness of flexure area 28 determine how far base 18 is spaced away from equatorial plane 26, which in turn determines the diameter of the opening into cavity 16. The resilience invested in flexure area 28 by the material and wall thickness choices determine the force necessary to insert male tip 14A into female cavity 16. Material resilience and wall thickness of flexure area 28 also determine the force with which tip 14A is engaged by cavity 16. Thicker flexure area 28 and stiffer material result in an overall tighter fit, but also recommend a larger opening so that a reasonable force will insert tip 14A into cavity 16. However, while increasing the per unit area loading of the resulting joint and increasing its frictional holding power, the necessarily larger opening decreases the total contact area and reduces the joint's holding power. Surface finish is an additional factor in determining the joint's frictional holding power, and the diameter of cylindrical cavity 20 is a factor in determining the total contact area between rounded tip 14 and cup-shaped cavity 16. In general, the factors of material, surface finish, thickness of flexure area 28, and the respective diameters of cylindrical cavity 20 and the opening in base 18 into cavity 16 are chosen to result in a positive and secure assembly that at least: (1) is relatively easily assembled and disassembled, (2) provides sufficient holding power to substantially rigidly support the entire assembly, described in detail below, and the additional mass of an external load, such as a map holder, a note pad, or a relatively light weight electronic instrument, such as a small computer or wireless telephone; and (3) is easily positionally adjustable.

Additionally, the relative diameters of tip 14A and cavity 16 are chosen to result in an interference fit one with the other, such that engaging spherical tip 14A with cavity 16 causes sufficiently high contact loading and resultantly high friction between the interconnected members to maintain a selected relative orientation under substantial external loading against typical gravitational, vibrational, and shock forces otherwise tending to change that relative orientation.

FIG. 2 also illustrates the effect of the relative sizing and positioning of tip 14 and conical body 12. As shown in FIGS. 1 and 2, tip 14 is sized with an equatorial diameter 30 larger than the diameter of conical body 12 at their mutual intersection. The intersection of tip 14 and conical body 12 is preferably smoothed by a radial fillet and/or a short substantially cylindrical neck portion 32. The length of skirt portion 34, extending between equatorial plane 26 of female cavity 16 and base 18, relative to the distance 36 from equatorial plane 30 of male tip 14 to its intersection with conical body 12 at neck 32 determines the degree of angular inclination to which link 10A is rotatably adjustable relative to interconnected second link 10 . In practice, cup-shaped cavity 16 of link 10 slidingly engages and substantially surrounds rounded end point 14 of link 10A. The geometric center of spherical tip 14A defines a pivot point 38A fixed relative to body 12A and lying within cup-shaped cavity 16 of body 12. Cavity 16 is thus pivotable about pivot point 38A such that body 12 is angularly inclinable relative to body 12A assembled therewith. Pivot point 38A defines the vertex of a conical sweep zone within which body 12 is relatively rotatably adjustable. Contact interference between base 18 of link 10 and the wall of body 12A adjacent to tip 14A restricts the relative angular inclination of link 10 and the inclination angle α defining the conical sweep zone. The inclination angle α is preferably limited to a predetermined maximum angle of about 20 degrees by interference between base 18 and the wall surface of body 12A at neck area 32. Thus, an assembly of about five links 10 provides a maximum inclination angle of about 90 degrees in any direction.

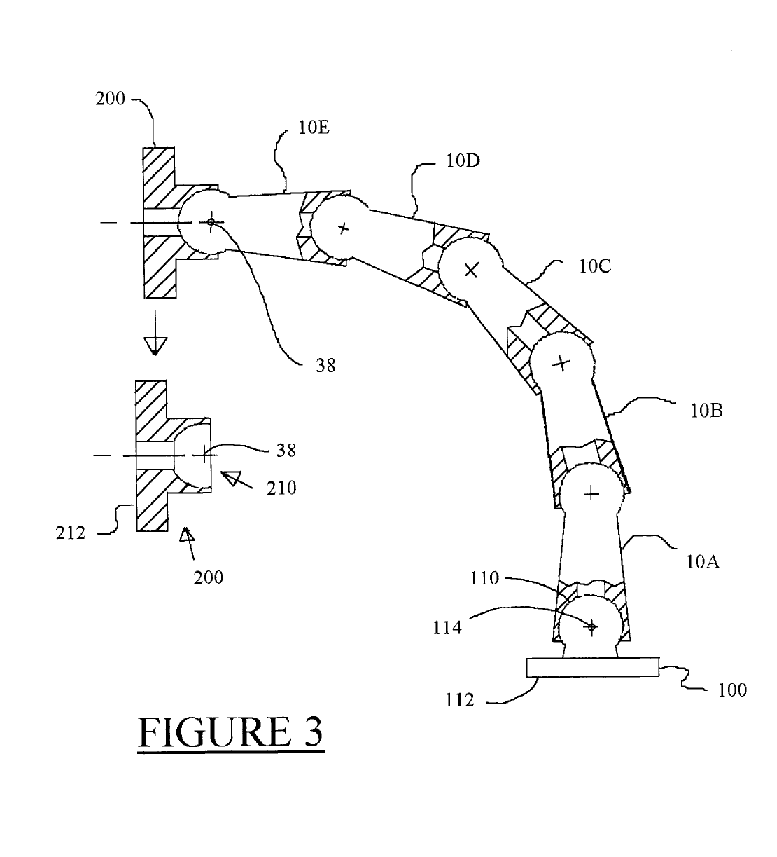

FIG. 3 illustrates an assembly of five links 10A through 10E in combination with a male mounting base 100 and a female equipment mount 200. According to the invention, each of mounting base 100 and equipment mount 200 are either male or female, as discussed in detail below. As described above in connection with link 10, each of mounting base 100 and equipment mount 200 are preferably molded of a relatively rigid, high-resiliency non-metallic material, preferably a plastic material, such as a thermoplastic which is suitable for use in an injection molding operation. In FIG. 3, links 10A through 10E are relatively radially rotatably interconnected by insertion of rounded end tips 14 into cup-shaped cavity 16 of adjacent links 10. Each interconnected link assembly is adjustable within a predetermined conical sweep zone defined by the allowable inclination angle a between them. Cavity 16A of first end link 10A is slidingly engaged with a rounded projection 110 integrally formed with base 100. Rounded projection 110 is formed substantially similarly to rounded end portion 14 of interconnecting links 10 for insertion into cavity 16 of one of links 10. The geometric center 114 of rounded projection 110 defines a fixed pivot point within cavity 16, whereby a link 10A engaged with projection 110 is rotatably adjustable relative to base 100 within a predetermined conical sweep zone, the vertex of which is pivot point 114. Base 100 is also formed with a mounting surface 112 adapted for permanent mounting on a substantially planar surface. Mounting surface 112 is described in detail below. In practice, mounting base 100 is permanently secured to a convenient surface in the user's automobile, boat, airplane, or other vehicle.

Equipment mount 200 is provided with an integral cup-shaped cavity 210 formed substantially similarly to cavity 16 of link 10 and substantially matching rounded end portion 14 for partially surrounding and relatively radially rotatably engaging rounded end portion 14 of one link 10. Therefore, mount 200 is similarly radially rotatably adjustable relative to a link 10 inserted into cavity 210 about pivot point 38 defined by the geometric center of tip 14, pivot point 38 thereby defining the vertex of a conical sweep zone. Equipment mounting surface 212 is preferably adapted for substantially permanently engaging or mounting an electronic equipment mounting receptacle. Mounting surface 212 is preferably formed on a surface of equipment mount 200 opposite cavity 210.

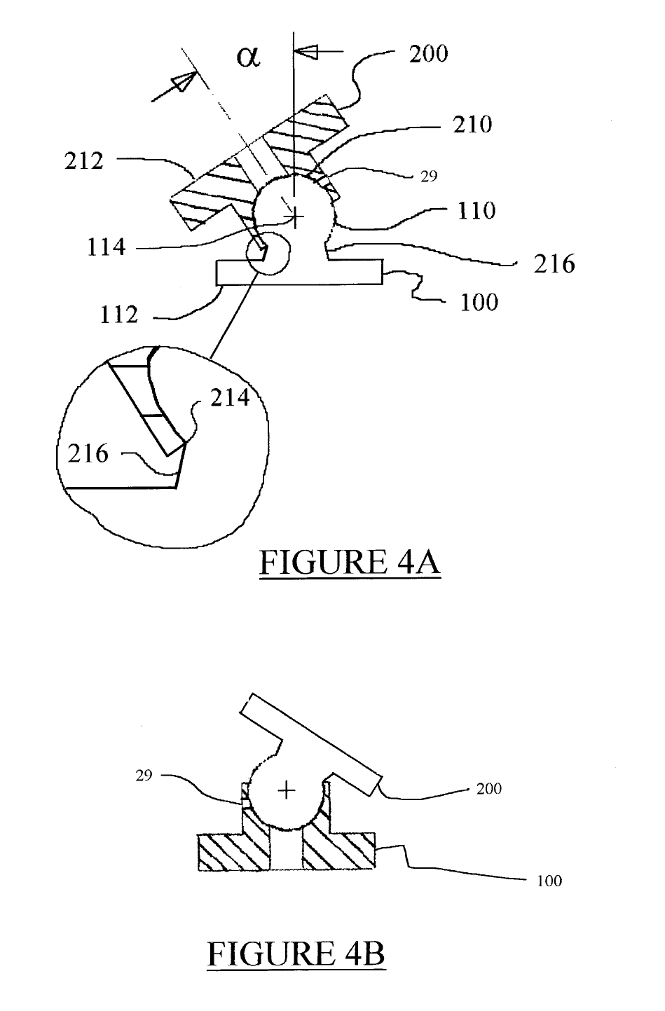

FIG. 4A illustrates the assembly of above described mounting base 100 with above described equipment mount 200. As described, male mounting base 100 is formed with integral rounded projection 110, while female equipment mount 200 is provided with an integral cup-shaped cavity 210. Rounded projection 110 is formed substantially similarly to rounded end portion 14 of interconnecting links 10 for insertion into cavity 16 of one of links 10. Integral cup-shaped cavity 210 is formed substantially similarly to cavity 16 of link 10 and substantially matching rounded end portion 14 for partially surrounding and relatively radially rotatably engaging rounded end portion 14 of one link 10. Therefore, as illustrated in FIG. 4A, cavity 210 of equipment mount 200 is formed to slidingly engage and partially surround rounded projection 110 of mounting base 100. Assembly of rounded projection 110 with cavity 210 results in a relatively radially rotatably assembly of mounting base 100 with equipment mount 200, as shown.

Equipment mount 200 is angularly inclinable relative to mounting base 100 assembled therewith. The geometric center 114 of rounded projection 110 defines a fixed pivot point within cavity 210, whereby equipment mount 200 engaged with projection 110 is rotatably adjustable relative to base 100 within a predetermined conical sweep zone of angle α, the vertex of which is pivot point 114. Contact interference between annulus 214 of equipment mount 200 and the projecting column 216 supporting the tip of rounded projection 110 restricts the relative angular inclination of equipment mount 200 and the angle α defining the conical sweep zone. The inclination angle α is preferably limited to a predetermined maximum angle of about 20 degrees by interference between annulus 214 and the wall surface of projecting column 216. Thus, an assembly of equipment mount 200 with mounting base 100 provides a maximum inclination angle of about 20 degrees in any direction.

As described below, various mounting surface configurations are applicable to both mounting base 100 and equipment mount 200. Therefore, according to one embodiment of the invention alternative to the embodiment of FIG. 4A, FIG. 4B illustrates a mounting base 100 formed in a female configuration while equipment mount 200 is formed according to a male configuration. Thus, the embodiment of FIG. 4B is substantially a mirror image of the embodiment of FIG. 4A and operates in substantially identical manner. FIGS. 4A and 4B further illustrate that each of female mounts 100 and 200 optionally includes a small passage 29 formed between the outer surface of the body and the female cavity for introduction of an adhesive for permanently fixing the relative orientation of mounting base 100 with equipment mount 200.

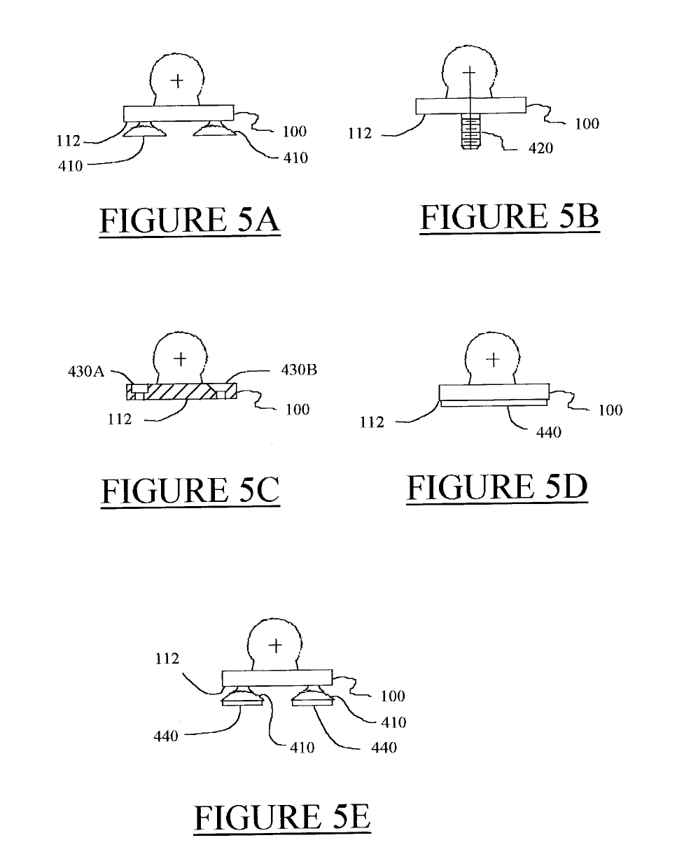

FIG. 5 illustrates some of the many various adaptations for permanent mounting intended for mounting surface 112. Many of these adaptations are similarly applicable to equipment mounting surface 212 of equipment mount 200. In FIG. 5 one of mounts 100 and 200 are formed with a respective mounting surface 112 and 212 which provides a predetermined minimum amount of substantially flat surface area 112, 212. One mounting adaptation shown in FIG. 5A is a pattern of suction cups 410 attached to mounting surface 112 or 212 (not shown) for removably attaching mount 100 or 200 to a substantially smooth and substantially flat or slightly curved surface, preferably a smooth metallic or glass surface, such as a vehicle dash board, console or windshield. Another adaptation shown in FIG. 5B includes one or more threaded studs 420 projecting from the mounting surface. FIG. 5C shows an adaptation wherein one or more preferably cylindrical passages 430 are formed through a flange portion 432 surrounding respective rounded projection 110 and cavity 210 and sized to accept a suitable screw for fastening to a selected surface. Passages 430 are optionally counterbored 430A or countersunk 430B. Alternatively, passage or passages 430 are threaded bores (not shown) for accepting a threaded fastener. FIG. 5D shows yet another adaptation in which a resilient adhesive pad 440, commonly known as Pressure Sensitive Adhesive or PSA, is bonded onto a respective surface 112, 212. Resilient adhesive pad 440 is equipped with an adhesive on its external surface for bonding to a substantially smooth and substantially flat surface, and is further provided with sufficient resilient thickness to effectively bond to a slightly irregular and/or curved surface. Additionally, other suitable mounting adaptations are similarly contemplated by the invention and are considered to be within the scope of the recited claims. FIG. 5E, for example, illustrates another alternative mounting adaptation in which a resilient adhesive pad 440 is applied to a pattern of suction cups 410 attached to mounting surface 112 or 212 (not shown) for permanently bond mounts 100 and 200 to a slightly irregular and/or curved surface.

Additional Alternative Embodiments

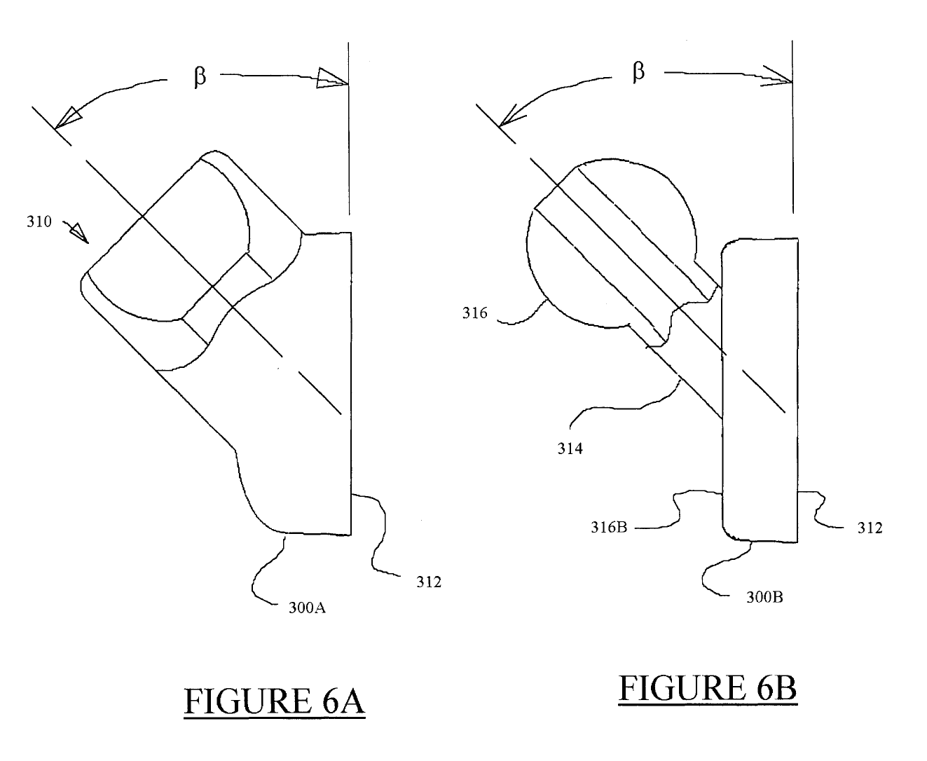

FIGS. 6A and 6B illustrate alternative embodiments of the mounting base of the invention. The embodiments of FIGS. 6A and 6B are intended primarily for mounting on a substantially vertical vehicle surface. When the base is mounted on a substantially vertical, or at least non-horizontal, dashboard or console surface, the invention thereby provides a relatively adjustable ball and socket mounting device that is installed in an essentially upright position, without the necessity of adding an interconnecting link 10 between the base and the interconnected equipment mount.

In FIG. 6A, inclined mounting base 300A is integrally formed in a female configuration with an integral cup-shaped cavity 310 that is angularly inclined at a predetermined angle β relative to mounting surface 312. In the example illustrated, cavity 310 is angularly inclined at about an angle β of 45 degrees relative to mount surface; 312. However, while inclination angle β is preferably less than or equal to 45 degrees to provide a substantially upright mount, inclination angle β is optionally any acute angle. Integral cup-shaped cavity 310 is formed substantially similarly to cavity 16 of link 10 and substantially matching rounded end portion 14 for partially surrounding and relatively radially rotatably engaging either rounded projection 110 of male equipment mount 200 or rounded end portion 14 of one link 10. Mounting surface 312A is configured for mounting to virtually any vehicle surface according to one of the many various adaptations for permanent mounting described above in connection with FIGS. 5A through 5E.

FIG. 6B illustrates male configured inclined mounting base 300B, which is formed with a shaft 314 projecting from base 316B at a predetermined inclination angle β, which is preferably about 45 degrees but is alternatively any acute angle between 0 and 90 degrees. Shaft 314 truncates a preferably spherical rounded end portion 316 formed substantially identically to rounded tip 14 of link 10 for relatively radially rotatably engaging one of cavity 16 link 10 and cavity 210 of female equipment mount 200. Mounting surface 312B is configured for mounting to virtually any vehicle surface according to one of the many various adaptations for permanent mounting described above in connection with FIGS. 5A through 5E.

FIG. 7 illustrates one alternative embodiment of the interconnecting link of the invention in which one or more of cavities 16, 210, and 310, shown in FIGS. 3 and 4, respectively, are formed of first part hemispherical cavity 16A, as described above, and a an opposing annular ring or lip 450. According to this embodiment of the invention, in Section A′-A′ of link 10′ cavity 16′ includes first part hemispherical cavity 16A intersected at equatorial plane 26 by a substantially cylindrical hollow section 452 that ends in annular ring 450 formed in base 18. The diameter of annular ring 450 is selected to engage and retain a spherical tip 14 of an interconnecting link 10, while the length of cylindrical hollow section 452 is selected to bring the inner edge of annular ring 450 into forceful contact with the diameter of inserted spherical tip 14. In mathematical terms, the radial distance R1 from the center of hemispherical cavity 16A to the inner rim of annular ring 450 opposite equatorial plane 26 is less than less than the diameter of spherical tip 14 and is preferably about the same as radius R2 of hemispherical cavity 16A. The length “L” of cylindrical hollow section 452 in combination with the diameter “D” of annular ring 450 determines radial distance R1 according to the Pythagorean theorem:

R1=((D/2)\hat{ }2+L\hat{ }½.

In operation, flexure area 28 flexes to allow annular ring 450 to expand during insertion of spherical tip 14 and springs back to press the inner rim of annular ring 450 against the outer surface of inserted spherical tip 14, and urge it against the interior surface of part hemispherical cavity 16A.

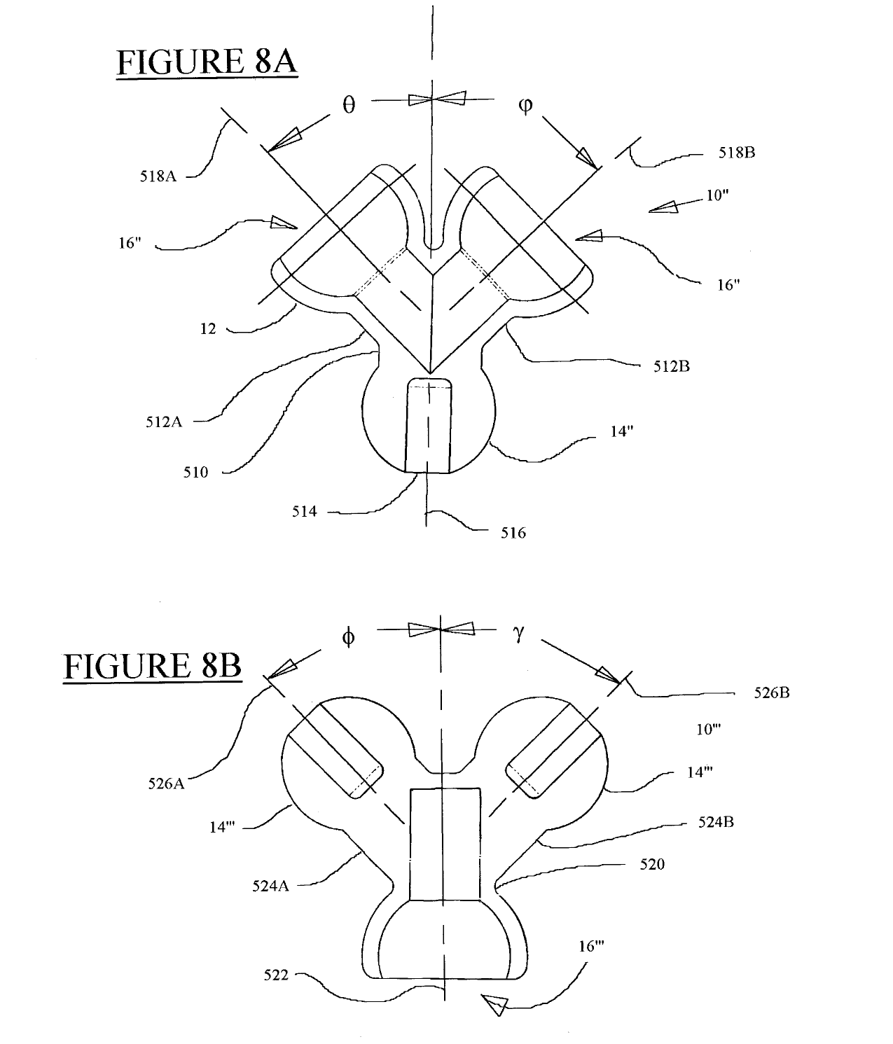

FIG. 8A illustrates another alternative embodiment of the interconnecting link of the invention. Link 10″ has the ability to mount two or more independent equipment mounts 200. As shown, the body 12″ of link 10″ is formed with a “Y” shaped shaft having a single stem 510 and two branches 512. Additional branches 512 are added in various alternative embodiments of the invention. According to the embodiment of the invention shown in FIG. 8A, stem 510 is formed with an integral bulbous tip 14″, preferably formed as a spherical body truncated at one polar region defined by an intersection of with stem 510. Preferably, spherical tip 14″ is also truncated by elimination of its polar region distal from stem 510. Truncation of tip 14″ is preferably accomplished by a cylindrical cavity 514 formed in tip 14″ along the longitudinal axis 516 of stem 510. Alternatively, the polar region of tip 14″ either remains or is truncated by a plane substantially perpendicular to longitudinal axis 516.

Two or more branches 512A and 512B project from stem 510 at respective predetermined angles θ and φ. Each of branch angles θ and φ are independently variable between 0 degrees and about 45 degrees from longitudinal axis 516. However, each of branch angles θ and φ are preferably inclined at about 45 degrees. Furthermore, when link 10″ is formed with two branches 512A and 512B, their respective longitudinal axes 518A and 518B preferably lie in a single plane with longitudinal axis 516 of stem 510 to balance external loads. Each branch 512 is formed with a cavity 16″ that is substantially identical to one of cavity 16 and cavity 16′, as described above. Cavities 16″ each preferably lie along respective longitudinal axes 518A and 518B of branches 512A and 512B distal from the body of respective branches.

In use, tip 14″ of stem 510 is plugged into and relatively rotatably engaged by a cavity 210 or 310 of a female mounting base 100 or 300A. One male equipment mount 200 is inserted into each cavity 16″ of branches 518A and 518B. Thus, an assembly is formed of two equipment mounts 200 that are rotatable as a whole relative to mounting base 100. Additionally, each equipment mount 200 is independently rotatable relative to both mounting base 100 and other equipment mounts 200 interconnected to other branches 512.

Alternatively, one or more links 10 are interconnected between mounting base 100 and branching link 10″. Accordingly, the entire assembly of branching link 10″ and multiple equipment mounts 200 is positionally adjustable as a whole, while maintaining a close relative proximity of multiple equipment mounts 200. Other alternatives include interconnecting one or more links 10 between one or all of branches 512 and corresponding equipment mount 200. According to this alternative, each equipment mount 200 is easily positionally adjustable independent of other equipment mounts 200, but the whole of the assembly remains adjustable as a whole by direct manipulation of branch link 10″.

FIG. 8B illustrates another multi-branched link 10′″ formed to mate with a male mounting base 100 and accept multiple female equipment mounts 200. Link 10′″ is formed with a single stem 520 having a truncated spherical cavity 16′″ formed integrally therein substantially concentrically with longitudinal axis 522 of stem 520. Truncated spherical cavity 16′″ is preferably formed substantially identically with cavity 16, as described above, to be relatively rotatably engaged with rounded projection 110 of male mounting base 100. Link 10′″ is further formed with multiple branches 524A, 524B, through 524N (not shown). In FIG. 8B, the invention is described having two branches 524A and 524B, but this description is not intended to limit the invention to only two such branches. Each branch 524A and 524B is formed substantially concentrically with a respective longitudinal axis 526A and 526B. Each branch 524A and 524B is angled away from longitudinal axis 522 of stem 520 at respective predetermined angles φ and γ. Each of branch angles φ and γ are independently variable between 0 degrees and about 45 degrees from longitudinal axis 516. However, each of branch angles φ and γ are preferably inclined at about 45 degrees. Each of longitudinal axis 526A and 526B preferably lie in a plane with longitudinal axis 522 of stem 520 when the implementation of the invention includes only two branches 524A and 524B so that external loads can be more easily balanced. Each branch 524A and 524B is formed with a rounded tip 14′″ that is substantially identical to truncated rounded tip 14, as described above. Each rounded tip 14′″ is formed substantially concentric with corresponding longitudinal axis 526A and 526B. Each male branch 524 is optionally equipped with one female equipment mount 200.

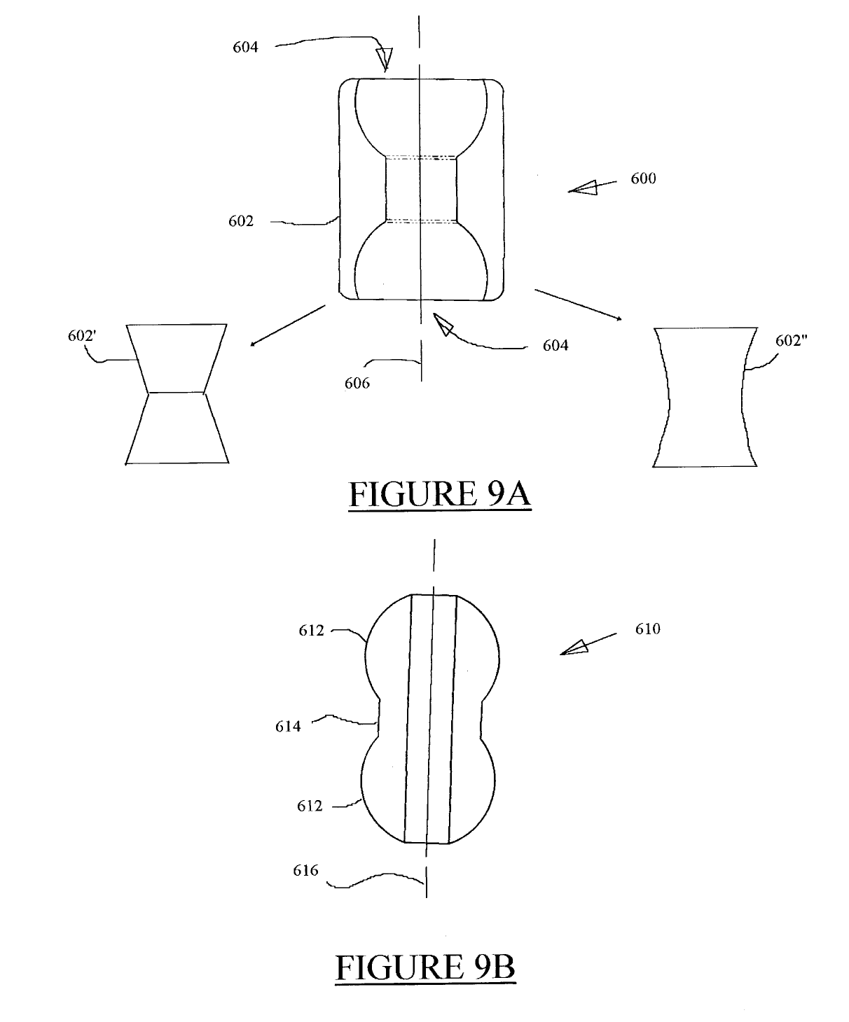

As described above in connection with FIG. 8A, multiple alternative configurations are contemplated by the invention, wherein one or more links 10 are interconnected between male mounting base 100 and branch link 10′″ to form an adjustable equipment mount of the invention. Other alternatives include interconnecting one or more links 10 between one or more of branch 524 and a corresponding female equipment mount 200, whereby each equipment mount 200 is easily positionally adjustable independent of other equipment mounts 200, but the whole of the assembly remains adjustable as a whole by direct manipulation of branch link 10′″. FIGS. 9A and 9B illustrate yet other alternative embodiments of the link element of the present invention for interconnecting same gender mounting bases and equipment mounts. In FIG. 9A, link 600 is formed of a substantially cylindrical body 602 using the above described relatively rigid and highly resilient non-metallic material. Link 600 is optionally formed with body 602′ having two conical shapes each truncating the other at their pointed ends. Link 600 is also optionally formed with body 602″ having a reentrant curve, or with body 602 having a barrel shape (not shown) or another suitable linear or complexly curved shape. Body 602 is formed with two opposing cavities 604, each formed substantially symmetrically with longitudinal axis 606 of body 602. Each cavity 604 is preferably formed substantially identically to above described cavity 16 for relatively rotatably engaging one rounded tip 14 or one rounded projection 110. Thus, one cavity 604 of female-female link 600 interconnected with one male mounting base 100 and the other cavity 604 interconnected with one male equipment mount 200 forms an assembly that is mountable in a vehicle and provides a substantially stable, load-bearing but relatively adjustable ball and socket mounting device for supporting any of various small office items, such as street maps and note pads, and relatively light weight electronic instruments, such as hand-held computers, navigation devices and wireless telephones.

Alternatively, female-female link 600 is interconnected with one male configured inclined mounting base 300B, shown in FIG. 6B, and one male configured equipment mount 200.

FIG. 9B illustrates another same gender embodiment of the link element of the present invention. Link element 610 is also formed using the above described relatively rigid and highly resilient non-metallic material. Link element 610 provides two integrally formed truncated rounded tips 612 projecting from a generally cylindrical body 614. Preferably, each rounded tip 612 is substantially symmetrically aligned with a longitudinal axis 616 of body 614. Rounded tips 612 are formed substantially identically to rounded tip 14, as described above, to be inserted into and relatively rotatably engaged by a socket 16 of link 10.

In operation, male-male link 610 provides an interconnection between one female mounting base 100 and one female equipment mount 200 to form an assembly that is mountable in a vehicle and provides a substantially stable, load-bearing but relatively adjustable ball and socket mounting device for supporting any of various small office items, such as street maps and note pads, and relatively light weight electronic instruments, such as hand-held computers, navigation devices and wireless telephones.

Alternatively, male-male link 610 is interconnected with one female configured inclined mounting base 300A, shown in FIG. 6A, and one female configured equipment mount 200.

Furthermore, each of links 600 and 610 illustrated in respective FIGS. 9A and 9B are interconnectable with link 10. Thus, an assembly of female-female link 600 with male mounting base 100 and male equipment mount 200 is extendable for both length and relative inclination angle by interconnection of one or more male-female links 10, 10′ in the chain of link elements between mounting base 100 and equipment mount 200. An assembly of male-male link 610 with female mounting base 100 and female equipment mount 200 is similarly extendable by interconnection of one or more links 10, 10′.

Those of ordinary skill in the relevant art recognize that the present invention is not limited to the adjustable mounting device described above and shown in the FIGURES. For example, the columnar shape of body 12 of link 10, including the dimensions and aspect ratios, may vary while remaining effective for the practice of the present invention. Similarly, the shapes, the dimensions and aspect ratios of either or both of mounting base 100 and equipment mount 200 may vary without limiting the effective practice of the invention. However, the above described adjustable mounting device uses simple geometric shapes been shown to be effective in production situations.

In another example, the multiple branched links of FIGS. 8A and 8B are combined with the female-female and male-male links of FIGS. 9A and 9B such that multiple branched links are formed with female stems joined to multiple female branches and are also formed with male stems joined to multiple male branches.

Although the foregoing invention has been described in detail for purposes of clarity, it will be obvious to those of ordinary skill in the relevant art that certain modifications may be practiced within the scope of the appended claims.

I claim:

1. An adjustable ball and socket mounting device comprising:
a first mounting element integrally formed with a base adapted to permanently attach to a surface external to the mounting device and one of:
i) a socket formed of a part hemispherical chamber and an opposing annulus, and
ii) a part spherical tip having a diameter larger than a diameter of said socket and an inner diameter of said annulus; and
a second mounting element integrally formed with a base adapted to permanently attach to a load external to the mounting device and the other one of:
i) a socket formed of a part hemispherical chamber and an opposing annulus, and
ii) a part spherical tip having a diameter larger than a diameter of said socket and an inner diameter of said annulus; and
said socket slidingly engaging said part spherical tip in a relatively radially rotatable interference fit with sufficient elastic clamping force to maintain relative orientation between said first and second mounting elements while supporting an external load at said second mounting element.

2. The mounting device recited in claim 1, wherein each of said first and second mounting elements are molded of a relatively rigid and highly resilient non-metallic material.

3. The mounting device recited in claim 2, wherein said annulus further opposes said part hemispherical chamber across an equatorial plane of said socket, said annulus defining an inner rim spaced a radial distance less than or equal to the radius of said chamber away from the center of said equatorial plane of said part hemispherical chamber.

4. The mounting device recited in claim 3, wherein said annulus further comprises a second part hemispherical chamber portion opposing said first part hemispherical chamber.

5. The mounting device recited in claim 3, wherein said socket further comprises a passage between an outer surface thereof and an inner surface of said part hemispherical chamber.

6. The mounting device recited in claim 3, further comprising an elongate ball and socket element interconnected between said socket and said part spherical tip, said elongate ball and socket element comprising:
a socket formed of a part hemispherical chamber and an opposing annulus each sized substantially identically to a respective one of said part hemispherical chamber and said annulus of said mounting element and formed in one end; and
a part spherical tip sized substantially identically to said part spherical tip of said mounting element and formed in an opposing end.

7. The mounting device recited in claim 6, wherein said interconnected ball and socket element further comprises a conical body having said socket formed in the base thereof, said part spherical tip truncating the vertex of said conical body at a position along the longitudinal axis thereof having a diameter less than the diameter of said part spherical tip.

8. The mounting device recited in claim 7, wherein said conical body further comprises an inner wall defining a longitudinal cavity communicating with at least one of said part hemispherical socket and said part spherical tip.

9. The mounting device recited in claim 3, further comprising a ball and socket element interconnected between said socket and said part spherical tip, said ball and socket element comprising:
a socket formed of a part hemispherical chamber and an opposing annulus each sized substantially identically to a respective one of said part hemispherical chamber and said annulus of said mounting element;
a part spherical tip sized substantially identically to said part spherical tip of said mounting element; and
at least another of one of said socket and said part spherical tip.

10. The mounting device recited in claim 9, wherein said socket further comprises a passage between an outer surface thereof and an inner surface of said part hemispherical chamber.

11. A flexible mounting assembly, comprising:
a plurality of adjacent interconnected substantially rigid columnar elements, each said columnar element having a bulbous end portion and a cup-shaped cavity formed at opposing ends and symmetrically coincident with a longitudinal axis thereof, each of said bulbous end portion and said cup-shaped cavity respectively sized to resistively rotatably engage the other;
a first mount formed with an integral bulbous portion projecting from a base, said bulbous portion sized to resistively rotatably engage said cup-shaped cavity of one of said columnar elements, said base adapted to substantially permanently receive an attachment thereto; and
a second mount having a cup-shaped cavity formed integrally within a base, said cup-shaped cavity sized to resistively rotatably engage said bulbous end portion of one of said columnar elements, said base adapted to substantially permanently receive an attachment thereto.

12. The flexible mounting assembly recited in claim 11, wherein:
each said columnar element further comprises a truncated conically-shaped column having said cup-shaped cavity formed within the base of said conically-shaped column; and
said bulbous end portion truncates the tip of said conically-shaped column at a point along the longitudinal axis of said conically-shaped column at which the diameter of said conically-shaped column is less than a diameter of said bulbous end portion.

13. The flexible mounting assembly recited in claim 12, wherein each said columnar element when engaged with another of said columnar elements forms an assembly that is rotatably adjustable within a predetermined conical sweep zone.

14. The flexible mounting assembly recited in claim 13, wherein:
said bulbous end portion is formed in a generally spherical shape truncated on one side of its equatorial plane by intersection with said conically-shaped column; and
said cup-shaped cavity is formed in a generally spherical shape truncated on one side of its equatorial plane by intersection with the base of said conically-shaped column.

15. The flexible mounting assembly recited in claim 14, wherein said truncation of said generally spherical shape of said cup-shaped cavity further comprises a predetermined amount of truncation that adapts said cup-shaped cavity to slidingly engage said bulbous end portion.

16. The flexible mounting assembly recited in claim 15, wherein:
said generally spherical shape of said bulbous end portion is truncated a predetermined amount; and
said assembly of said truncated bulbous end portion and said truncated cup-shaped cavity forms a contacting overlap of said truncated portion of said bulbous end portion and said truncated portion of said cup-shaped cavity.

17. The flexible mounting assembly recited in claim 16, wherein said generally spherical shape of said bulbous end portion defines a fixed pivot point within said cup-shaped cavity, said pivot point defining the vertex of said conical sweep zone.

18. The flexible mounting assembly recited in claim 17, wherein contact between said base of said conically-shaped column member and a wall of said truncated column member adjacent to said bulbous end portion restricts said conical sweep zone.

19. A flexible electronic equipment mounting assembly, comprising:
a plurality of adjacent interconnecting columnar links, each of said columnar links further comprising:
(i) a substantially rigid elongated cone-shaped column,
(ii) a rounded end portion formed substantially symmetrically coincident with a longitudinal axis of said cone-shaped column adjacent to and truncating the vertex end thereof,
(iii) a cavity formed substantially symmetrically coincident with said longitudinal axis within the base of said cone-shaped column, and
(iv) said cavity of one said interconnecting columnar member adapted to partially surround and resistively relatively radially rotatably engage said rounded end portion of an adjacent one of said columnar links;
a mounting base formed with a mounting surface adapted for permanent mounting on an substantially planar surface and a rounded projection formed similarly to said rounded end portion of said interconnecting columnar links for interconnecting with said cavity of one of said interconnecting columnar links; and
an electronic equipment mount formed with a mounting surface adapted for permanent mounting of an electronic equipment mounting receptacle and a cavity formed similarly to said cavity of said interconnecting columnar links for partially surrounding and relatively radially rotatably engaging said rounded end portion of one said interconnecting columnar link.

20. The mounting assembly recited in claim 19, wherein said rounded end portion of each said columnar link and said rounded projection of said mounting base each define a fixed pivot point in one said cavity engaged therewith, whereby each columnar link is radially rotatable relative to one of: an adjacent interconnected columnar link, and one of said mounting base and said electronic equipment mount engaged therewith.

21. The mounting assembly recited in claim 20, wherein:
said cavity is further pivotable about said pivot point of one of said rounded end portion and said rounded projection engaged therewith such that said columnar link is angularly inclinable relative to said one of: an adjacent columnar link interconnected therewith, and one of said mounting base and said electronic equipment mount engaged therewith;
said pivot point defines the vertex of said conical zone swept by said columnar link; and
said relative angular inclination of said columnar link is limited by interference between said base of said columnar link and a surface adjacent one of said rounded end portion and said rounded projection engaged therewith.

22. The mounting assembly recited in claim 21, wherein each said cavity and each said rounded end portion is further sized to form an interference fit one with the other, such that said engaging of one of said rounded end portions by one of said cavities forms an interference fit.

23. The mounting assembly recited in claim 22, wherein each of said columnar links and each of said mounting base and said electronic equipment mount are formed of a relatively rigid and highly resilient non-metallic material.

24. The mounting assembly recited in claim 23, wherein each of said permanent mounting surface and said rounded projection are formed on substantially opposing surfaces of said mounting base.

25. The mounting assembly recited in claim 24, wherein each of said permanent mounting surface and said cavity are formed on substantially opposing surfaces of said electronic equipment mount.

26. A method for mounting office or electrical equipment in a vehicle, the method comprising:
permanently mounting on a substantially planar surface a mounting base formed with one of a rounded projection and a cavity sized to partially surround and relatively radially rotatably engage said rounded projection,
interconnecting to said mounting base an equipment mount formed with a mounting surface adapted for mounting of an equipment mounting receptacle and an other of said rounded projection and said cavity.

27. The method recited in claim 26, further comprising interconnecting between said mounting base and said equipment mount a substantially rigid link element having a rounded end portion and an opposing cavity each formed substantially identically to a respective one of said rounded projection and said cavity.

28. The method recited in claim 26, further comprising introducing an adhesive into a joint formed by said interconnecting of said mounting base and said equipment mounting receptacle.

29. An adjustable ball and socket mounting device comprising:
a first mounting element integrally formed with a base adapted to permanently attach to a surface external to the mounting device and one of:
i) a part spherical tip, and
ii) a socket formed of a part hemispherical chamber and an opposing annulus; and
a second mounting element integrally formed with a base adapted to permanently attach to a load external to the mounting device and the same one of said part spherical tip and said socket;
a link element integrally formed with two of an other of said part spherical tip and said socket, said link element interconnecting said first and second mounting elements; and
each said socket slidingly engaging said part spherical tip in a relatively radially rotatable interference fit with sufficient elastic clamping force to maintain relative orientation between said first and second mounting elements while supporting an external load at said second mounting element.

30. The mounting device recited in claim 29, wherein said first and second mounting elements and said link element are each molded of a relatively rigid and highly resilient non-metallic material.

31. The mounting device recited in claim 30, wherein said annulus further opposes said part hemispherical chamber across an equatorial plane of said socket, said annulus defining an inner rim spaced a radial distance less than or equal to the radius of said chamber away from the center of said equatorial plane of said part hemispherical chamber.

32. The mounting device recited in claim 31, wherein said annulus further comprises a second part hemispherical chamber portion opposing said first part hemispherical chamber.

33. The mounting device recited in claim 31, wherein:
each of said first and second mounting elements are formed with substantially identical ones of said sockets; and
said link element further comprises a substantially columnar body formed with one said part spherical tip at each opposing end thereof.

34. The mounting device recited in claim 31, wherein:
each of said first and second mounting elements are formed with substantially identical ones of said part spherical tips; and
said link element further comprises a substantially columnar body formed with one said socket at each opposing end thereof.
